(19) United States
(12) Patent Application Publication
(10) Pub. No.: US 2025/0231391 A1
(43) Pub. Date: Jul. 17, 2025

(54) ASSISTED AUTOFOCUS METHOD AND ASSOCIATED OPTICAL IMAGING SYSTEM

(71) Applicant: Schölly Fiberoptic GmbH, Denzlingen (DE)

(72) Inventors: Christian DROBNIK, Vörstetten (DE); Stefan SCHRÖER, Freiburg (DE)

(73) Assignee: Schölly Fiberoptic GmbH, Denzlingen (DE)

(21) Appl. No.: 18/853,533

(22) PCT Filed: Feb. 16, 2023
(86) PCT No.: PCT/EP2023/053893

§ 371 Date: Oct. 2, 2024

(30) Foreign Application Priority Data
Apr. 19, 2022 (DE) 10 2022 109 399.9

(51) Int. Cl. G02B 21/24; G02B 21/00

(52) U.S. Cl. CPC G02B 21/245; G02B 21/0012; G02B 21/0036; G02B 21/006; G02B 21/244

(57) ABSTRACT

To improve the accuracy and the speed of an autofocus method by which it is possible to automatically find a current best focal plane (13) which provides the best possible image quality for an object (3) situated at a certain working distance (11) from an optical imaging system (1), a spatial location and preferably at least one further parameter of a z-scan (17) performed to find the best focal plane (13) is modified on the basis of an estimated value (41) for the working distance (11). In this case, the estimated value (41) can be determined on the basis of site information retrieved from an external system, for example an image-based navigation system (36) or a robotics system (34) used to displace the imaging system (1). The assisted adaptation of the autofocus thus allows shortening the time required to find the best focal plane (13).

### CROSS-REFERENCE TO RELATED APPLICATIONS

This application is a 371 National Phase of PCT/EP2023/053893, filed Feb. 16, 2023, which claims priority from German Patent Application No. 10 2022 109 399.9, filed Apr. 19, 2022, both of which are incorporated herein by reference as if fully set forth.

### TECHNICAL FIELD

The invention relates to an autofocus method, i.e. a method for automatically finding a current best focal plane. In this method, the location of a focal plane of the optical imaging system is displaced along an optical z-axis within a scan range by detuning a focusing lens of an optical imaging system. This displacement of the focal plane is also referred to as a z-scan. The focusing lens can be detuned by for example displacing the focusing lens and/or tuning the focusing lens (provided the latter is designed to be tunable). Moreover, an object can be visualized with the aid of the imaging system once the autofocus method has been carried out. In this case, the visualization can be implemented on the basis of the ascertained best focal plane with an optimized image quality since the autofocus enables precise focusing on the object.

The invention also relates to an associated optical imaging system with which such an autofocus method can be implemented. In particular, this imaging system can be used to visualize an object during a medical procedure. The imaging system comprises a focusing lens that is detunable by means of a focus actuator (i.e. it is displaceable and/or tunable, for example) in order to adapt the location of a focal plane of the imaging system along an optical z-axis during a z-scan; an image sensor for recording image data; and lastly a controller for controlling the focus actuator.

### BACKGROUND

In general, autofocus (AF) refers to the technology of a camera or other optical equipment that automatically focuses on an object to be observed. In this context, a distinction is made between an active autofocus which operates even without ambient light and a passive autofocus in which only the light emitted or reflected by the object is used for focusing purposes. Moreover, passive autofocus systems are known to include an assessment of individual focal planes in view of the respective image quality, for example by a phase comparison or a contrast measurement, in particular an edge contrast measurement, in order to thus find the location of a best focal plane. In this case, the best focal plane corresponds precisely to the plane which is closest to the plane in which the object is located and thus offers the best image sharpness for the object to be visualized.

Autofocus methods of the type set forth at the outset are known and used in many different ways, in particular in medical visualization systems such as endoscopes, exoscopes or microscopes. Especially in medical microscope applications, the working distance (WD) of the utilized optical imaging system may vary within a very large range since great flexibility is typically required in relation to the positioning of the imaging system within the area where the surgeon performs their work. However, a large variation in the working distance may be an impediment to an efficient implementation (i.e. especially a fast implementation) of the autofocus, especially when an image-based autofocus is used.

If the working range within which the working distance changes is large, then an image-based autofocus system, which for example is based on a contrast-based image sharpness assessment, often requires much too much time to find the best focal plane, i.e. the best possible focus position for imaging the object, when traversing the entire working range. This is because any change in the working distance then typically requires a renewed run-through in order to search for the best focal plane.

To this end, the image-based determination of the best focal plane typically includes an analysis of an image stack or an incremental search for the best focal plane. However, the frame rate of the image sensor limits the number of images available per second in such approaches. This also limits the speed at which the entire working range can be traversed. This is because a scanning speed of the z-scan that is too high harbors the risk of no longer being able to find the best focal plane. As a result, finding the best focal plane often takes too long.

There are also approaches of carrying out the z-scan only once at the outset and subsequently tracking the focal plane, i.e. displacing the latter by a certain path along the z-axis (“refocus”/“adjust focus”) if a change in the working distance is noticed. Although a new focal plane can be set quickly in this case, this may give rise to an error between the location of the current focal plane and the actual best focal plane over time in the case of multiple instances of tracking, and so the object is imaged with increasing blurriness. In this case, speed is therefore increased to the detriment of image quality.

To avoid the above-described problem, the prior art often provides for the installation of an additional laser autofocus, or a phase detection approach is chosen in order to determine the focus position and the focus direction, and hence accelerate the search for the best focal plane. Approaches involving artificial intelligence to determine the focus position are also the subject of current developments. However, all of these approaches are likewise accompanied by disadvantages, for example increased spatial requirements for additional hardware, significant demands on computational performance, or the generation of disturbing radiation by the AF auxiliary light, to name but a few.

### SUMMARY

Using this as a starting point, the problem addressed by the invention is that of improving already known autofocus methods. In particular, the intention is to provide an assisted passive autofocus which can react quickly and precisely, and preferably continuously, to changes in the working distance and which always supplies sharp images of the object to be visualized.

According to the invention, one or more of the features disclosed herein are provided to solve the stated problem. In particular, to solve the problem for an autofocus method of the type described at the outset, the invention therefore proposes that external site information is retrieved (preferably automatically by the imaging system itself), that an estimated value for a current working distance between the imaging system and the object is calculated from the external site information, and that a location of the scan range (within which the z-scan is carried out) on the optical z-axis (for example a z-coordinate zc of a center of the scan range and/or a start coordinate z1 of the scan range) is adapted on the basis of the estimated value. Subsequently, the z-scan, which is thus adapted in terms of its location, can be carried out in order to identify or find the best focal plane within the scan range (defined on the basis of the estimated value).

The invention thus proposes an assisted autofocus which offers improved accuracy and speed in relation to already known autofocus methods. In this context, the assistance is based on the site information retrieved from an external system. The scan range of the autofocus, i.e. the range in which the method searches for the best focal plane, is positioned in space on the basis of this site information, or on the basis of the estimate for the current distance between the imaging system and the object to be visualized (=working distance) derived from the site information, and optionally further adapted on the basis of the estimated value (for example in terms of the length, the spatial scanning frequency or the zoom level used during the z-scan). As a result, the autofocus method adapts intelligently to the respective current working situation and can thus quickly and reliably find the current working distance or the current best focal plane.

In principle, the imaging equation allows a respective working distance (and hence a desired object distance Sₒ) to be associated with specific detuning of the focusing lens, i.e. for example a specific position of the focusing lens on the z-axis in the case of a displaceable focusing lens. Thus, the focusing lens can be detuned, for example at the start of the z-scan, in such a way that the current focal plane is located at the lower limit of the new scan range. For example, for a scan range of X mm, the lower limit can be set to the z-position of z1=estimated value (working distance)−X/2. Initially, this also does not require any image evaluation.

The actual z-scan can be implemented incrementally in particular, with the result that the z-scan is stopped (for example on the basis of a termination criterion) when the best focal plane is found, further accelerating the method.

It is particularly advantageous in this context if an optical imaging system according to the invention, in particular as described herein or as claimed in any of the claims directed to an optical imaging system, is used in the method according to the invention. At this point, it should also be observed that the focusing lens can naturally also be formed by a complex lens group; this lens group might also comprise a plurality of detunable focusing lenses. For example, an axially displaceable first focusing lens can be used for the coarse displacement of the focal plane, and an additional tunable liquid lens can be used for the fine displacement of the focal plane.

In this case, the z-axis may be predefined by the optical imaging system, in particular by its viewing direction.

An advantage of this method is that carrying out the z-scan allows the location of the best focal plane, and hence also the actual currently present working distance between the imaging system and the object, to be ascertained even more precisely than by estimation alone. This is because the calculated estimated value for the working distance will typically have a residual error (=difference between the estimated value and the actual currently present working distance). This residual error can be reduced or even entirely eliminated by carrying out the z-scan which has been adapted in terms of its position. The reason for this is that the autofocus then searches for the actual best focal plane in the region of the estimated working distance and is thus able to ascertain the actual working distance (which correlates with the z-position of the best focal plane) which may hence deviate from the estimated value.

A further advantage of the method, which will become clearer below, consists in the fact that the process of finding the best focal plane can be accelerated. The root cause of this lies in the fact that the optimized location of the scan range allows the length of the scan range to be shortened from the outset, in comparison with already known methods. However, this also means that less time is required for carrying out the necessary optical scanning of the focal planes within the scan range, and this accelerates the process of finding the best focal plane.

It has also transpired that avoiding unnecessary sampling points, i.e. focal planes optically scanned unnecessarily, outside of a region of interest leads to more sampling points for the autofocus being able to be placed within the region of interest, i.e. within the scan range of the z-scan, within a reasonable period of time. That is to say, in comparison with already known methods, the scan range can be smaller but optically scanned at a higher spatial scanning frequency. This can increase the spatial z-resolution when determining the location of the best focal planes on the z-axis.

According to the invention, the problem can also be solved by further advantageous embodiments, which are described in the dependent claims and explained below:

Initially, it should be highlighted that carrying out the z-scan in the scan range whose location (on the z-axis) was adapted on the basis of the calculated estimated value differs from merely tracking the focus, for instance by adjusting the focusing lens on the basis of the estimated value. This is because the estimated value does not yet define the final detuning of the focusing lens and hence the location of the final focal plane (as best focal plane) ultimately ascertained/defined by the method (=result of the autofocus). The estimated value merely supplies the method with a first indication as regards to the scan range in which an expedient search should be carried out for the best focal plane by carrying out the z-scan. In other words, the method can thus distinguish itself in that the location of the identified best focal plane is ascertained independently of the estimated value. Hence the focusing lens will be detuned independently of the estimated value following the implementation of the method, in such a way that it defines the best focal plane identified.

In the vast majority of cases, specifically when the estimated value is afflicted with errors, the best focal plane ascertained with the aid of the z-scan can be located at an object distance Sₒ from the imaging system, and this object distance deviates from the estimated value for the current working distance. In the unlikely case of the estimated value for the working distance being without errors, the ideal best focal plane would be located precisely at an object distance from the imaging system which corresponds to the working distance.

Especially in comparison with merely tracking a current focal plane without a renewed z-scan by way of a single adjustment of the focusing lens on the basis of the estimated value, the approach according to the invention can thus improve an accuracy when determining the best focal plane.

According to a development, a deviation between an object distance Sₒ defined by the ascertained best focal plane (i.e. the above-described object distance in particular) and the estimated value can be stored. This deviation can then be taken into account in subsequent z-scans. For example, the deviation can form an offset which is always taken into account when choosing the current location of the scan range of the z-scan. For example, in the case of a subsequent z-scan (for example carried out if the working distance has changed again and this is identified on the basis of the retrieval of the external site information), the adaptation of the spatial location of this subsequent z-scan can be implemented on the basis of the stored deviation/offset. In this case, the offset can also be re-adapted from time to time, for example if a current deviation arises between the object distance Sₒ arising from the currently ascertained best focal plane and the current estimated value, and this current deviation differs significantly (e.g. above a threshold value in terms of absolute value) from the stored offset.

Ascertaining such an offset in particular has the advantage that whenever for example the estimate of the distance between an operating region and the image recording system, i.e. the aforementioned estimated value of the working distance, is systematically inaccurate, for example because the operating region has cavities that cannot be seen by the image-based navigation system used to ascertain the estimated value, such situations can be resolved more accurately, in the sense that despite the systematic error, unnecessary sweep regions can be avoided during the z-scan. This, too, can accelerate the process of finding the best focal plane.

The imaging system which carries out the method (more precisely the controller thereof) can thus store the amount by which the location of the most recently ascertained best focal plane (=optimal focus position) deviates from the working distance estimated on the basis of the external site information (for example ascertained on the basis of external measuring means), in order to take this into account for a future start of the z-scan (=autofocus routine). This can further accelerate the process of finding the best focal plane because irrelevant search regions that only had to be traversed on account of errors with regard to the estimated value can be avoided from the outset.

To avoid unnecessary z-scans from the outset and thus save more time, provision can be made for a corrected estimated value to be calculated initially on the basis of the stored deviation and for the focusing lens to be detuned such that the location of the current focal plane corresponds to the corrected estimated value. Thus, this is used to initially remove/compensate the offset ascertained previously. In this case, this focal plane, the location of which corresponds to the corrected estimated value, can then be initially assessed, preferably by means of an image-based evaluation, in particular by evaluating the image contrast. For example, the z-scan can be subsequently carried out only if this current focal plane is/was assessed as insufficiently sharp. That is to say, if this focal plane already exhibits a satisfactory image quality, then this focal plane can be assumed to be the new best focal plane, and so no further z-scan needs to be carried out. In this context, threshold values can also be used as a criterion for the image quality. For example, focal planes found by means of the stored deviation can be accepted as best focal planes until a detected edge contrast or a different statistic drops below a threshold value defined in advance.

The external site information, on the basis of which the estimated value for the working distance is ascertained, can be obtained in many different ways. For example, the external site information can be based on current measured data from at least one location sensor and/or at least one acceleration sensor. For instance, this approach lends itself to the case where the optical imaging system which carries out the autofocus is secured to a manually movable support arm or support frame, in which case the working distance is then manually adaptable by the surgeon. This is because the sensors can be used to determine the current spatial position and/or orientation of the support arm, and hence of the imaging system supported thereby, and this information can be used as the external site information.

As an alternative to that or in addition, the site information can also be retrieved from a robotics system used to move the imaging system in space. This movement of the imaging system with the aid of the robotics system can precisely serve the purpose of modifying the actual working distance, for example according to the requirements of the user. In this case, the site information can describe in particular a current spatial position and/or orientation of a component of the robotics system carrying the imaging system. For example, this component can be a robot arm.

Further, it is also possible to obtain or retrieve the site information from an external navigation system, in particular an external image-based navigation system. Such navigation systems are known from robot-assisted surgery and are already used in that context for placing a microscope for the surgeon in space in order thus to be able to visually monitor an operation, in particular remotely as well.

In such a configuration, it is preferable for the navigation system to be an image-based/camera-based navigation system. For example, an external camera of the navigation system can be moved together with the imaging system in space, in particular by means of a/the above-described robotics system. In comparison with navigation systems based on stationary cameras, this approach is advantageous in that the estimated value for the working distance can be ascertained with a greater accuracy using the moving camera of the navigation system.

In particular, such an external navigation system can be realized with the aid of a 3-D camera. In this context, optical tracking approaches known per se (in particular those using optical markers whose location can be tracked using the camera) can also be used to supply the site information on which the estimate of the working distance is based.

Thus, the invention can be implemented in such a way that a retrieval of position from an external system (i.e. for example a navigation camera, a location and/or acceleration sensor and/or a robot position) is used for positioning purposes and/or for restricting the scan range covered by the z-scan (=search range for finding the best focal plane), to be precise in order to thus realize an assisted image-based autofocus in particular.

According to a preferred configuration, the site information can be chosen such that a spatial location and/or an orientation of the imaging system, in particular a spatial location and/or orientation of an optical assembly of the imaging system, relative to the object is ascertainable from the site information. This is advantageous in that the estimated value can then be calculated particularly precisely from the ascertained location and/or orientation. For example, this can thus allow deviating viewing angles, for instance between the imaging system and the navigation camera, to be taken into account when calculating the estimated value. For example, depending on the current position and/or orientation in space, the viewing angle of the imaging system may deviate from the viewing angle of an optical assistance system (for example an additional camera) used to ascertain the estimated value, and these deviations can be taken into account when calculating the estimated value. This can reduce the size of the residual error of the estimated value, and this in turn allows a reduction in the size of the scan range required for reliably finding the best focal plane. As a result, this allows the autofocus to be accelerated.

In order to allow the best focal planes to be found as quickly as possible, it is eminently efficient for at least one further parameter of the z-scan to be adapted automatically on the basis of the estimated value for the current working distance. In particular, such a parameter can a length of the z-scan and/or a number of focal planes optically scanned by the z-scan within the scan range and/or a spatial scanning frequency of the z-scan (e.g. a spatial scanning frequency of 10 focal planes/4 mm) and/or an optical zoom level of the imaging system used during the z-scan adapted automatically. In this context, the zoom level is understood to mean the zoom focal length currently set. By contrast, the zoom factor is typically understood to mean the ratio between the longest and the shortest zoom focal length settable with the aid of a zoom lens. Thus, there is a low zoom level in the case of a short zoom focal length (wide angle), and so a comparatively large image section is imaged in that case and only a small magnification is obtained. By contrast, a high zoom level is obtained in the case of a long zoom focal length (tele), and so only a small image section is imaged in that case and hence a large magnification is obtained. In other words, the change in zoom always brings about a change in the optical magnification.

Thus, the proposed adaptation of the at least one further parameter of the z-scan not only adapts the location of the z-scan in space but also allows the z-scan to be tailored to the current recording situation. For example, there can be a change in the depth of field depending on the optical zoom settings and the current working distance. In general, the depth of field is understood to mean the extent of the region, in front of and behind the focal plane, in which a point is still imaged sufficiently sharply. In this case, the focal plane is the plane in the object space whose points are imaged as sharp points on the image plane (typically corresponding to the plane of the image sensor) in the image space by the imaging system. By contrast, points away from the focal plane are imaged on the image plane/image sensor as circles or ellipses, i.e. with a certain amount of blur. In other words, the depth of field thus determines the range of possible focal planes in which an image is still perceived as sharp or can be reproduced/recorded with a sufficient image quality by an image sensor.

In the case of already known autofocus methods, for example contrast-based autofocus methods, the spatial resolution used to scan the individual focal planes is typically always chosen to be smaller than the minimum depth of field of the optical system used for imaging. As mentioned previously, the depth of field in this case depends on the working distance and the set optical zoom. Such a small increment when scanning the focal planes offers the advantage that the respective position of the focal plane which supplies an optimal image quality for a certain object located at a given working distance from the front lens can be determined with sufficient accuracy. In this context, this focal plane is referred to as the best focal plane. Then again, the described scanning of the possible focal planes with the smallest possible increment leads to the autofocus method becoming temporally inefficient or slow because oversampling often occurs. By contrast, if the spatial resolution is reduced when the different focal planes are scanned in order thus to accelerate the method, there is the risk that the best focal plane can no longer be found with sufficient accuracy, especially if the depth of field is currently small.

Thus, as a result of the adaptations proposed by the invention, it is possible to either actively adapt the depth of field (by changing the zoom level) and/or compensate a current change in the depth of field by virtue of implementing an appropriate adaptation of the z-scan (adaptation of the scanning frequency and/or length and/or number of focal planes scanned). For example, it makes sense to reduce the length of the z-scan and/or reduce the number of scanned focal planes and/or increase the scanning frequency in the event of a reduction in working distance because the depth of field typically is also reduced in that case. Moreover, depending on the estimated working distance, it may be advantageous to modify the optical zoom/optical zoom level for the purpose of accelerating the z-scan. This is because the depth of field can also be adapted by changing the zoom level.

Since the length of the z-scan can vary but it is often sufficient to carry out the z-scan within a maximum scan time available, provision can be made in particular for the spatial scanning frequency to be increased as soon as the length of the scan range is reduced. In particular, this can be configured in such a way that the overall time required for performing the z-scan is kept constant in each case (wherein this overall time is limited as a matter of principle by the maximum possible scanning frequency of the utilized image sensor and by the maximum adjustment speed of the focusing lens). As a result, a specified available maximum overall time for the z-scan can be exploited optimally in each case (either for a comparatively long z-scan or else for a comparatively high-resolution z-scan).

To avoid bothersome disturbing radiation, the method according to the invention can be implemented as a passive autofocus method, i.e. without using additional AF lighting. This offers additional advantages. For example, this is because an active laser autofocus requires additional space for the components required to provide the AF light. These spatial requirements can thus be economized, and this has advantages if the method is implemented by an imaging system according to the invention which is moved in space by a robot arm.

To enable a configuration of the optical imaging system that is as compact and simple as possible, it is further advantageous if, within the method, the location of the best focal plane is ascertained on the basis of an image evaluation of the focal planes optically scanned by means of the z-scan. This is because the evaluation of image data supplied by an image sensor of the imaging system in any event is sufficient in this case. However, the image evaluation should preferably comprise an evaluation of an image contrast in order to reliably find the best focal plane. For this purpose, it is possible in particular to create a respective edge map of the individual optically scanned focal planes (or of the correlating image data) and/or apply a respective Fourier transform to image data from the focal planes.

According to the invention, the presented method can thus be implemented in particular as an image-based and/or contrast-based autofocus method. This has decisive advantages over the use of a phase-based autofocus or the use of artificial intelligence (AI) for assessing the focal planes: An autofocus by way of phase detection requires either additional detectors on the image sensor for detecting the phase or separate sensors which obtain the image by means of beam splitters and hence reduce the optical efficiency. Additionally, the performance typically deteriorates in the case of low contrast values in this approach. By contrast, in addition to the significant need for resources in respect of hardware (computing performance), AI approaches for determining the focus also require data records for learning the network forming the AI that are as comprehensive as possible.

To be able to always react dynamically to an adaptation of the actual working distance, it is moreover advantageous if the location of the scan range is adapted anew and the z-scan adapted thus is performed again as soon as a change in the site information and/or the calculated estimated value is ascertained on the basis of a renewed retrieval of the external site information. In this case, retrieving the external site information on a continual basis is advantageous for a fast adaptation.

A further gain in speed of the autofocus method can be obtained if the site information comprises target coordinates. This is because the focusing lens can already be detuned in this case while the imaging system is moved to a new position, in particular to new target coordinates. In this context, the target coordinates need not necessarily correspond to the new spatial location of the imaging system. This is because the target coordinates can for example describe a position in space to which a robot arm supporting the imaging system should be displaced. Once the robot arm has reached this position, the position of the imaging system can deviate from the new target position of the robot arm by a constant offset. In the case of such a configuration, it is advantageous if the z-scan is only performed once the imaging system has reached the new position/the target coordinates and has stabilized in terms of its spatial location. This is because movement artifacts when recording the focal planes can be avoided in this case.

Further, to solve the problem set forth at the outset, the invention proposes the features of the independent device claim for an optical imaging system. Thus, in particular, to solve the problem for an optical imaging system of the type set forth at the outset, the invention proposes that the controller is configured to choose a location of a scan range of the z-scan on the optical z-axis on the basis of an estimated value for the current working distance and subsequently carry out the z-scan within the scan range which has been adapted in this way in terms of its location, in order to identify a best focal plane within the scan range.

As already mentioned above, the controller in this case displaces the respective current focal plane along the z-axis by virtue of appropriately controlling the focus actuator in order to thus trigger the necessary detuning of the focusing lens. Optical scanning of the focal planes can be implemented by a respective readout of the image sensor of the imaging system. This is because the image data reproduce the image quality of the object to be visualized that can be obtained by way of the current focal plane. On the basis of an image evaluation, the controller can then decide which of the scanned focal planes should be used as best focal plane for the purpose of recording further image data (for instance a video frame data stream).

For example, the estimated value for the working distance can be calculated by the controller itself. To this end, it can actively retrieve the external site information required for the calculation (or receive said information automatically at regular times; this is considered to be technically equivalent). It is also possible that an external system, for example the external navigation system, calculates the estimated value on the basis of site information and transmits said value to the controller. Thus, the controller need not calculate the estimated value itself in this case; however, the controller adapts the scan range on the basis of the estimated value.

Thus, provision can be made for the controller to be connectable or connected to an external system, in particular a navigation system and/or a robotics system (e.g. as described above in each case). In this case, the controller can be configured to retrieve the estimated value from the external system. In addition to that or in an alternative, the controller can also retrieve or obtain external site information from the system and calculate the estimated value from this site information itself.

As already explained, the imaging system can also comprise a zoom optical unit. This zoom optical unit can be adjustable by means of a zoom actuator, wherein the controller in that case is configured to control the zoom actuator on the basis of the estimated value, in order to thus adapt the zoom level used during the z-scan.

It is understood that it is particularly advantageous if the controller is precisely configured in such a way that it implements an autofocus method according to the invention, as described above and/or as claimed in any of the claims directed to such a method, wherein it can appropriately control the focus actuator and/or the zoom actuator to this end.

### BRIEF DESCRIPTION OF THE DRAWINGS

The invention will now be described in more detail with reference to exemplary embodiments but is not restricted to these exemplary embodiments. Further embodiments of the invention can be obtained from the following description of a preferred exemplary embodiment in conjunction with the general description, the claims, and the drawings.

In the following description of various preferred embodiments of the invention, elements that correspond in terms of function receive corresponding reference numerals, even if their designs or shapes deviate.

In the figures:

FIG. 1 shows individual components of an imaging system according to the invention,

FIG. 2 shows a schematic sketch of a typical application situation for the imaging system according to the invention from FIG. 1, which is used to visualize an object, wherein a z-scan is carried out in order to find a best focal plane,

FIG. 3 shows a much simplified illustration of the curve of an image contrast along the optical z-axis,

FIG. 4 shows an illustration of two z-scans performed in different situations, in order to find the location of a best focal plane in each case, and

FIG. 5 shows a further illustration of an autofocus method according to the invention, which comprises a coarse scan and two subsequent fine scans,

FIG. 6 shows an illustration of a possible application situation of a method according to the invention in a medical visualization system according to the invention,

FIG. 7 shows the individual steps when running through an autofocus method according to the invention, which comprises a coarse scan and a fine scan,

FIG. 8 shows a z-scan which is performed for a first estimated value of the working distance,

FIG. 9 shows a z-scan which is performed for a second estimated value of the working distance, which deviates significantly from that of FIG. 8, and

FIG. 10 shows two z-scans performed successively in time, which are each performed for different estimated values of the working distance, wherein the second z-scan takes account of an offset that was ascertained in the preceding z-scan.

### DETAILED DESCRIPTION

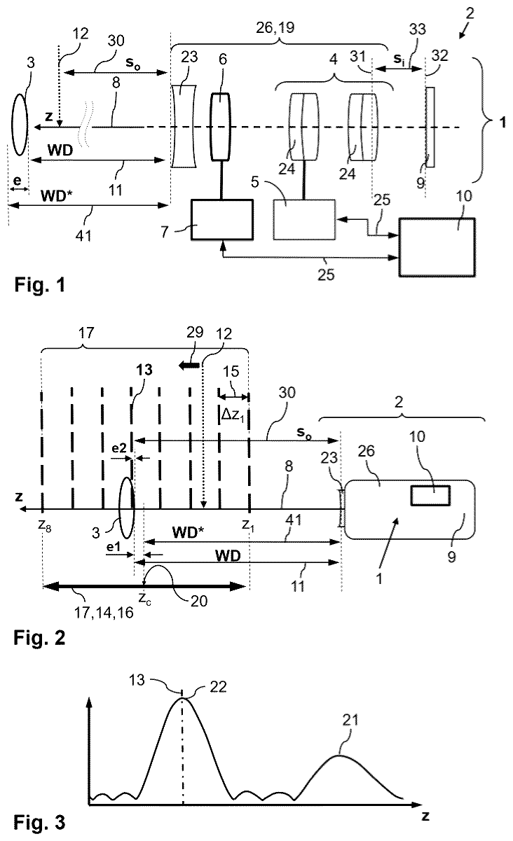

FIG. 1 shows an optical imaging system 1 according to the invention, which is configured to visualize an object 3 during a medical procedure. To this end, the optical imaging system 1 comprises a zoom optical unit 4 that is adjustable by means of a zoom actuator 5, in order to adapt an optical zoom level. Moreover, the imaging system 1 comprises a focusing lens 6 that is detunable by means of a focus actuator 7 in order to displace the current location of a focal plane 12 along the optical z-axis 8, as illustrated in FIGS. 1 and 2. A controller 10 is provided for controlling both the focus actuator 7 and the zoom actuator 5.

In this case, the dashed vertical lines of FIG. 2 specify the z-positions (e.g. z1 to z8) at which the focal plane 12 is positioned during a z-scan 17. That is to say the respective dashed vertical line in FIG. 1 specifies the position of the plane which—as a consequence of detuning the focusing lens 6—is currently imaged sharply on the image sensor 9 and consequently optically scanned.

As shown in FIG. 1, the zoom optical unit 4 comprises two zoom lenses 24, each in the form of an achromatic lens, wherein the front zoom lens can be displaced along the optical axis 8 with the aid of the zoom actuator 5 in order to thus zoom on the object 3 to a greater or lesser extent. The optical components 4 and 6 are combined with a front lens 23 in a compact objective 26. The front lens 23 is in the form of a diverging lens and thus enables a comparatively large working distance 11 between the front lens 23 and the object 3. Together with the illustrated image sensor 9, these components 4, 6 and 23 form a video camera 2.

As shown in FIG. 2, detuning the focusing lens 6 (which can be designed either as a lens that is displaceable along the z-axis 8 and/or as a tunable lens) allows displacement of the current focal plane 12 along the optical z-axis 8, for example incrementally with an increment 15 of Δz1 in the positive scan direction 29 (i.e. in the positive z-direction).

If the focusing lens 6 shown in FIG. 1 is designed as a displaceable lens, for example, and if this lens is displaceable at a continuous displacement speed along the z-axis 8, then the current focal plane 12 will also displace in a corresponding continuous fashion along the z-axis 8, wherein this movement may depend nonlinearly on a current z-position of the focusing lens 6. Reading out the image sensor 9 at regular time intervals thus allows an entire set of different (current) focal planes 12 to be optically scanned in each case during the continuous displacement of the current focal plane 12, as illustrated by the dashed vertical lines in FIG. 2. The choice of detuning speed of the focusing lens 6 and/or readout frequency of the image sensor 9 can thus adapt not only the respective length 16 of the scan range 14 traversed during the respective z-scan 17 but also the effective increment 15, i.e. the distance between two adjacent focal planes 12 which are scanned within the scope of such a z-scan 17 with the aid of the image sensor 9. Moreover, appropriate control of the focus actuator 7 also allows the location of the z-scan 17, in particular the z-coordinate zc of a center 20 of the scan range 14, to be adapted.

The scan range 14 illustrated in FIG. 1 can also be traversed continuously by virtue of the location of the focal plane 12 being displaced continuously within the scan range 14 while the image sensor 9 is read out. For example, the focusing lens 6 can be displaced at a constant displacement speed to this end. If the focusing lens 6 is configured as a tunable liquid lens, by contrast, then the location of the focal plane 12 can be displaced continuously along the z-axis 8 by continuously tuning the focusing lens 6. In such cases the mean scan speed at which the location of the focal plane 12 is displaced along the z-axis 8 can be adapted on the basis of the currently set optical zoom level and/or on the basis of an estimated value for the (current) working distance 11. Thus, the controller 10 can reduce the scan speed in the case of a zoom level increase, and the accompanying increasing image magnification, and/or in the case of a reduction in the estimated value for the working distance 11. This is because, provided that the image sensor 9 is read at a constant frequency (e.g. maximum frame rate) during the continuously carried out z-scan 17, the z-resolution increases when the scanning speed reduces since the z-distances between the individual focal planes 12, which are scanned in each case when the image sensor 9 is read out, decrease in that case. In other words, lowering the scan speed for a given maximum frame rate of the image sensor 9 thus allows the spatial scanning frequency, and hence the z-resolution when determining the best focal plane 13, to be increased.

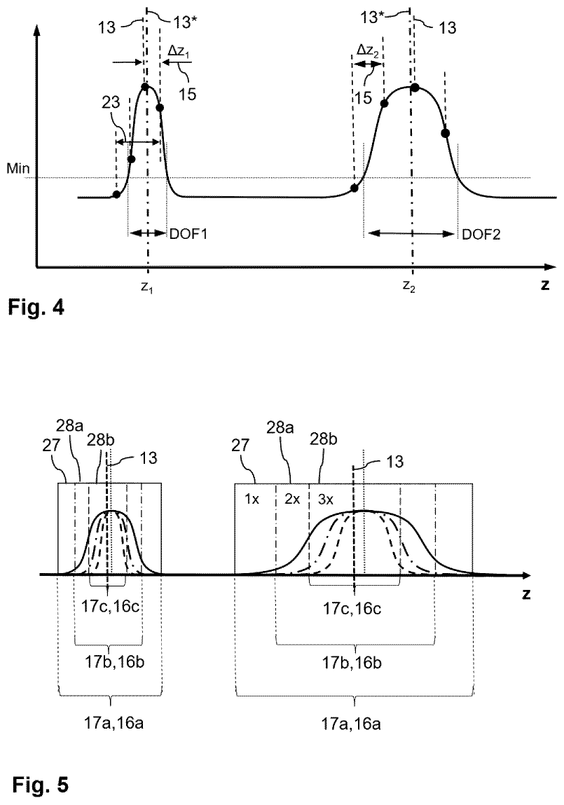

FIG. 3 shows a much simplified possible curve of an image sharpness (vertical axis) as a function of the z-coordinate. As shown, further local maxima 21 may also exist in addition to a global maximum 22 of the image sharpness in real application situations. In this case, the best focal plane 13 illustrated in FIG. 1 corresponds to the global maximum 22 of the image sharpness in FIG. 3. That is to say, if the focusing lens 6 is detuned in such a way that the current focal plane 12 is positioned at the current working distance 11 of the object 3 from the front lens 23, as illustrated in FIG. 1, then the object 3 is imaged with optimal image sharpness on the image sensor 9. In other words, the best focal plane 13 thus precisely corresponds to the focal plane 12 which is scanned with the aid of the imaging system 1 and comes closest to the plane in which the object 3 is located. As shown in FIG. 4, the best focal plane 13 determined using an autofocus method according to the invention might still deviate slightly from the actual best focal plane 13* in this case because the latter cannot be determined with an arbitrarily high z-resolution.

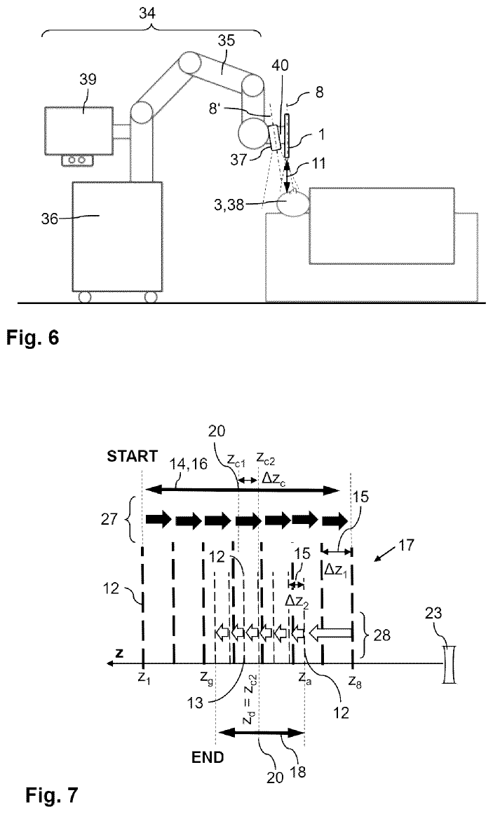

FIG. 6 shows a specific application situation for an imaging system 1 according to the invention during a medical procedure. The imaging system 1, which is configured as a microscope, is moved in space by a robot arm 35 of a robotics system 34 in order thus to adapt the working distance 11 from the object 3 (the patient 38 in this case) according to the wishes of the surgeon. The surgeon can observe the object 3 with appropriate magnification as a digital live image on the monitor 39. A further camera 37, which is a part of an external image-based navigation system 36, is secured to the robot arm 35, the spatial location of which is also monitored by way of location and acceleration sensors 40.

As indicated in FIG. 6 on the basis of the two optical axes 8 and 8′, the viewing angles of the camera 37 and of the microscope/imaging system 1 differ. Nevertheless, the navigation system 36 can provide site information from which the controller 10 calculates a reliable estimated value 41 WD* for the currently applicable working distance 11 between the imaging system 1 and the object 3. In this case, the site information provided by the navigation system 36 allows conclusions to be drawn with regards to both the location (xyz-position) and the orientation (alignment of the z-axis 8) of the imaging system 1, and this already allows a comparatively accurate estimate of the working distance 11. This situation is also illustrated in FIG. 2: nevertheless, the estimated value 41 (WD*) may still deviate from the actually present working distance 11 (WD) by an error e1. The task of the autofocus is therefore precisely not that of merely adjusting the focusing lens 6 such that the current focal plane corresponds to the error-afflicted estimated value; instead, it should minimize this error e1.

As explained below, the controller 10 of the imaging system 1 is configured to solve this problem by virtue of implementing an autofocus method according to the invention. To this end, the controller 10 controls the focus actuator 7 in such a way that the location of the scan range 14 of the z-scan 17 on the optical z-axis 8 is chosen on the basis of the estimated value 41 for the current working distance 11 that is present between the imaging system 1 and the object 3 to be visualized. In this case, the controller 10 itself can calculate the estimated value 41 on the basis of external site information which it retrieves from the navigation system 36, or the navigation system 36 carries out this calculation and supplies new estimated values 41 for the working distance 11 to the controller 10, for example at regular intervals

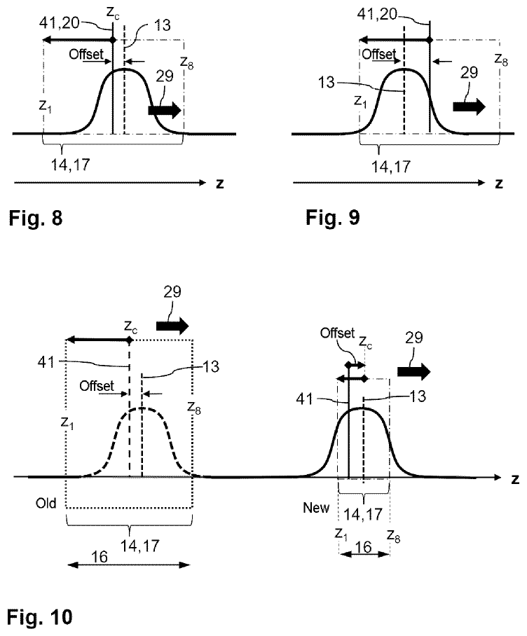

As already illustrated in FIG. 2, or else shown in FIGS. 8 and 9 as well, the controller 10 can for example in each case define the scan range 14 such that the coordinate zc of the center 20 of the z-scan 17 or of the scan range 14 corresponds to the estimated value 41 for the working distance 11. In this case, the autofocus thus searches around the estimated value 41 in symmetric fashion for the location of the best focal plane 13 in the scan range 14 (dashed box in FIGS. 8 and 9). Unlike merely tracking a focal location on the basis of the estimated value, however, the location of the best focal plane is ascertained independently of the estimated value 41, as shown by a comparison between FIG. 9 and FIG. 8: in both cases, the center 20 of the z-scan 17 was chosen in correspondence with the estimated value 41, wherein the z-scan of FIG. 9 was implemented as a consequence of a renewed retrieval of the site information, which resulted in a change in the estimated value 41. However, what is identifiable on the basis of the illustrated contrast curve recorded during the z-scan 17 with the aid of the image sensor 9 is that the estimated value 41 in the case of FIG. 8 underestimates the actual working distance 11 and hence the best focal position, while the working distance 11 in the situation of FIG. 9 is overestimated by the calculated estimated value 41. For example, this may be a consequence of an error e1, which grows as the working distance 11 increases. In the process, the size of the error e1 in terms of absolute value (cf. FIG. 2 to this end) has also changed. The method according to the invention largely compensates such varying errors by virtue of the location of the best focal plane 13 being determined on the basis of an image-based evaluation of the focal planes 12, which are successively optically scanned in the scan direction 29 during the z-scan 17. This assessment and hence the definition of the focal plane 12 ultimately identified as best focal plane 13 therefore does not depend on the estimated value 41; the latter merely determines the location of the z-scan 17

As a result, the ultimately ascertained best focal plane 13, as illustrated in FIG. 2, might be located at an object distance Sₒ 30 from the imaging system 1 which deviates from the estimated value 41 for the current working distance 11. This object distance Sₒ 30 set by detuning the focusing lens 6 might still have a residual error e2 with regard to the actual working distance 11. However, as a result of the high-resolution optical scan obtained by means of the z-scan 17, this error e2 will generally be smaller than the original error e1. That is to say, in comparison with merely tracking the focal location on the basis of the estimated value 11, there is an improved accuracy when determining the best focal plane 13. At this point, it should be observed that the detuning of the focusing lens specifies the location of the current focal plane 12 in accordance with the imaging equation. In this case, the image distance si 33, i.e. the distance between the last principal plane 31 of the imaging system 1 and the image plane 32 of the image sensor 9, remains constant (cf. FIG. 1). In this context, the planes 13 and 32 form optically conjugate planes

As explained below, even further parameters of the z-scan can be adapted by the controller 10:

In this case, consideration needs to be given to the fact that in the typical application situation shown in FIG. 6, both a zoom level (depending on the desire of the user) and the working distance 11 might change from situation to situation, and this might also give rise to a change in the depth of field (DOF), as illustrated in FIGS. 4 and 5. In order to accelerate the process of finding the best focal plane 13 in such situations, the controller 10 is able to independently choose the length 16 of the scan range 14, within which a certain number of focal planes 12 are scanned, and hence also the number of these focal planes 12. Further, depending on the situation, the controller 10 can also adapt, in the imaging system 1, the optical zoom level used during the described z-scan 17, i.e. when the imaging system 1 scans the different focal planes 12. Finally, the controller 10 can also adapt the spatial scanning frequency (scanned focal planes/mm). To this end, the controller 10 checks what zoom level is currently set and moreover takes account of the current estimated value 41 for the working distance 11 between the imaging system 1 and the object 3.

For example, FIG. 4 shows that whenever the object 3 is at a comparatively short working distance z1, the depth of field (DOF) is small, while the depth of field increases when the working distance increases, for instance to the value z2. Accordingly, the controller shortens the length 16 of the scan range 14 and thus also reduces the number of scanned focal planes 12 within the scan range 14 if the estimated value for the working distance 11 decreases. In this case, the increment 15 between the individual, scanned focal planes 12 can be maintained, for example. However, as illustrated in FIG. 4, an improvement in the z-resolution when finding the best focal plane 13 is obtained in particular whenever the increment 15 is reduced when the estimated value for the working distance 11 decreases (either as an alternative or in addition to the adaptation of the length 16 of the scan range 14), whereby the spatial scanning frequency is increased. This lends itself in particular whenever the scan range 14 is traversed incrementally by virtue of the location of the respective focal plane 12 being displaced incrementally at an increment 15 (for example Δz1, as illustrated to the left of FIG. 4).

Moreover, to accelerate the process of finding the best focal plane 13, it is advantageous to take account of the currently set optical zoom level of the imaging system 1. For example, if the zoom level has increased, i.e. if a large zoom focal length (tele) is currently used such that only a small image portion of the object 3 is imaged on the image sensor 9 and a large magnification of the object 3 is obtained accordingly, then it is sensible to shorten the length 16 of the scan range 14 or reduce the number of scanned focal planes 12 within the scan range 14. This is because the depth of field will reduce in the case of a high optical zoom level, in a manner analogous to a comparatively short working distance 11, and so the best focal plane 13 needs to be found within a smaller z-range along the optical z-axis 8.

As illustrated in FIGS. 5 and 7, at least two z-scans 27, 28 can also be carried out successively within the scan range 14 for the purpose of finding the best focal plane 13. In this case, the two z-scans 27, 28 might differ in terms of their respective length 18 and also in terms of the respectively used increment 15 or, for example, also in terms of the scanning speed used and, not least, also in terms of their respective location (for example mean z-position zc) within the scan range 14. In the example of FIG. 7, a first coarse z-scan 27 (with a comparatively large distance between the individual optically scanned planes 12) extends over the entire length 16 of the scan range 14. In comparison with the first coarse scan 27, the subsequently carried out fine scan 28 has a shorter increment 15 Δz2<Δz1 and a shorter length 18. Moreover, the coarse scan 27 is carried out at a lower zoom level and hence with a smaller image magnification than the fine scan 28.

In more detail, a minimal zoom level settable by means of the zoom optical unit 4 is initially set by the controller 10 for the purpose of performing the coarse scan 27 in the example of FIG. 7, and the coarse scan 27 is carried out over the entire scan range 14. Only subsequently is there a reset to a zoom level selected previously by a user for the purpose of recording a video image data stream, in order to perform the subsequent fine scan 28. On account of the smaller increment Δz2 of the fine scan 28, the local z-resolution obtainable by this scan 28 is higher than that of the previously performed coarse scan 27. At the same time, this two-stage procedure temporally accelerates the process of finding the best focal plane 13 since the fine scan 28 is carried out not over the entire scan range 24 but only within a smaller z-range which was identified previously with the aid of the coarse scan 27 and in which the best focal plane 13 is located.

These individual method steps are illustrated in FIG. 7 on the basis of the block arrows, it being identifiable that, initially, the individual focal planes 12 at the z-coordinates z1 to z8 are approached incrementally and recorded with the aid of the image sensor 9 (=coarse scan 27; black block arrows) and that, subsequently, the first focal plane 12 of the fine scan 28 at the z-coordinate za is approached. From there, the fine scan 28 is then subsequently performed incrementally up to the focal plane 12 at the z-coordinate zh. Hence, the fine scan 28 is thus implemented in the opposite scan direction 29 to the coarse scan 27.

To ascertain the estimated value for the working distance 11, the controller 10 is able to resort not only to the navigation system 36 or site information from a 3-D camera. In particular, the invention can also be implemented as follows: Using position data from the robotics system 34 illustrated in FIG. 6, the controller 10 is able to estimate the current working distance 11 (WD) and accordingly adapt the z-scan 17 to be performed for the purpose of finding the best focal location.

Hence, a first possible implementation can provide an image-based navigation system 36, for example a 3-D camera 37, which supplies the estimated value for the current working distance to the controller of the imaging system (wherein the controller implements an autofocus unit). Should the navigation system 36 identify a change in the current working distance, directional information for the autofocus can also be extracted so that the controller can select a suitable scan direction 29 for the z-scan 17. The determination of the best focal plane 13 (and hence a more accurate estimate of the actual working distance 11) can only be implemented in the stationary state of the system, i.e. precisely when there is no longer any change in the working distance 11 or the imaging system 1 is at rest in space.

A further possible implementation provides for the current working distance 11 to be estimated by way of actual coordinates of a robotics system 34 (for instance as illustrated in FIG. 6) using a geometric conversion. When the working distance 11 is changed by the robotics system 34, it is even possible to estimate the ultimately sought-after working distance 11 in advance on the basis of target coordinates that still need to be approached by the system 34.

A third possible implementation provides for a change in the working distance 11 between the object 3 to be visualized and the imaging system 1 to be detected by way of location/acceleration sensors (inertial measurement systems); this lends itself in particular if the location of the imaging system 1 in space or the working distance 11 is adjusted manually by the surgeon. Naturally, these various approaches can also be used in combination in order to always make available a precise estimated value 41 for the working distance 11.

In an alternative to that or in addition, however, the imaging system 1 may also comprise an additional sensor, for example a contactless distance sensor, or for example an additional camera 37. This is because such apparatuses can also be used to respectively ascertain a current estimated value for the working distance 11.

FIG. 10 finally shows two z-scans 17 performed successively in time, which are each performed for different estimated values 41 of the working distance 11, wherein the second z-scan 17 (right) takes account of an offset that was ascertained in the preceding z-scan 17 (left). As shown in the left image, the first z-scan 17 was initially positioned on the basis of the first estimated value 41-similar to FIGS. 8 and 9—such that its central position zc coincides with the estimated value 41. However, as can be seen, there was a deviation between the object distance Sₒ 30 defined by the ascertained best focal plane 13 and the estimated value 41. This deviation was stored as an offset. In the subsequent z-scan 17 (to the right in FIG. 10), which was performed for a new estimated value 11 in response to a detected change in the working distance 11, the spatial location of the z-scan 17 was adapted on the basis of the stored offset. To this end, the estimated value 41 was initially corrected by the offset, and the central position zc of the z-scan 17 was subsequently placed anew on the estimated value corrected thus. As shown, this allowed the scan length 16 to also be shortened because taking account of the offset (which approximately corresponds to the error e2 between the estimated value 41 and the actual working distance 11) already allows the scan range 14 to be aligned more accurately with the actual position/location of the object 3. However, the number of eight scanned planes (at points z1 to z8) was maintained at the same time, and so the spatial scanning frequency was increased. As a result, these adaptations allow the location of the best focal plane 13 to thus be determined more quickly and more accurately.

In conclusion, to improve the accuracy and the speed of an autofocus method by means of which it is possible to automatically find a current best focal plane 13 which provides the best possible image quality for an object 3 situated at a certain working distance 11 from an optical imaging system 1, it is proposed that a spatial location (z-position), by preference, and at least one further parameter of a z-scan 17 performed to find the best focal plane 13 is modified on the basis of an estimated value 41 for the working distance 11. To this end, the estimated value 41 can be determined on the basis of site information retrieved from an external system, for example an image-based navigation system 36 or a robotics system 34 used to displace the imaging system 1. The assisted adaptation of the autofocus thus allows the time required to find the best focal plane 13 to be shortened.

### LIST OF REFERENCE SIGNS

1 Optical imaging system
2 Video camera
3 Object
4 Zoom optical unit (displaceable or tunable)
5 Zoom actuator
6 Focusing lens (displaceable or tunable)
7 Focus actuator
8 Optical z-axis
9 Image sensor
10 Controller
11 Working distance (between 1 and 3)
12 (Current) focal plane (specified by 1 or 6)
13 Best focal plane (for imaging 3 optimally sharply on 9)
14 Scan range (along 8 in relation to 12)
15 Increment (distance between 12 following the incremental adaptation of the location of 12)
16 Length (of 14)
17 z-scan within 14
18 Length of 17
19 Assembly
20 Center (of 14)
21 Local maximum
22 Global maximum
23 Front lens
24 Zoom lens
25 (Bidirectional) control line
26 Objective
27 Coarse scan
28 Fine scan
29 (Current) scan direction (of 17)
30 Object distance Sₒ
31 Principal plane (in particular the last principal plane of 26)
32 Image plane (defined by the sensor area of 9)
33 Image distance si
34 Robotics system (designed to move 1 or adapt 11)
35 Robot arm
36 Navigation system
37 (External) camera
38 Patient
39 Monitor
40 Location sensor and/or acceleration sensor
41 Estimated value (for 11)

The invention claimed is:

1. An autofocus method for automatically finding a current best focal plane (13), the method comprising:
displacing a location of a focal plane (12) of an optical imaging system (1) along an optical z-axis (8) within a scan range (14) during a z-scan (17) by detuning a focusing lens (6) of the optical imaging system (1),
subsequently visualizing an object (3) with the imaging system (1),
retrieving an external site information,
calculating an estimated value (41) for a current working distance (11) between the imaging system (1) and the object (3) from the external site information,
adapting a location of the scan range (14) on the optical z-axis (8) based on of the estimated value (41), and
subsequently carrying out the z-scan (17) with the adapted scan range (14)
to identify the current best focal plane (13) within the scan range (14).

2. The autofocus method as claimed in claim 1, further comprising ascertaining the location of the identified best focal plane (13) independently of the estimated value (41), and
detuning the focusing lens (6) independently of the estimated value (41) following the implementation of the method,
such that the focusing lens (6) defines the best focal plane (13) identified in the z-scan (17).

3. The autofocus method as claimed in claim 1, wherein the best focal plane (13) ascertained with the aid of the z-scan (17) is located at an object distance Sₒ (30) from the imaging system (1) that deviates from the estimated value (41) for the current working distance (11),
in particular such that an accuracy in the determination of the best focal plane (13) is improved.

4. The autofocus method as claimed in claim 3, wherein a deviation between the object distance Sₒ (30) defined by the ascertained best focal plane (13) and the estimated value (41) is stored, and said deviation is taken into account in subsequent z-scans (17).

5. The autofocus method as claimed in claim 4, wherein a corrected estimated value (41) is initially calculated based on the stored deviation, and the focusing lens (6) is detuned such that the location of the current focal plane (12) corresponds to the corrected estimated value (41), and
said focal plane (12), the location of which corresponds to the corrected estimated value (41), is initially assessed.

6. The autofocus method as claimed in claim 1, wherein the external site information
is at least one of a) based on current measured data from at least one of a location or acceleration sensor (40),
b) retrieved from a robotics system (34) used to move the imaging system (1) in space,
or
c) retrieved from an external navigation system (36).

7. The autofocus method as claimed in claim 1, wherein the site information is chosen such that at least one of a spatial location or orientation of the imaging system (1) , relative to the object (3) is ascertainable from the site information.

8. The autofocus method as claimed in claim 1, wherein at least one further parameter of the z-scan (17), including at least one of
a length of the z-scan (17),
a number of focal planes (12) optically scanned by the z-scan (17) within the scan range (14),
a spatial scanning frequency of the z-scan (17), or
an optical zoom level of the imaging system (1) used during the z-scan (17),
is adapted automatically based on the estimated value (41) for the current working distance (11).

9. The autofocus method as claimed in claim 1, wherein the spatial scanning frequency of the z-scan (17) is increased when a length of the scan range (14) of the z-scan (17) is shortened.

10. The autofocus method as claimed in claim 9, wherein the adapting of the at least one parameter
at least one of a) actively adapts a depth of field, or
compensates for a current change in the depth of field.

11. The autofocus method as claimed in claim 1, wherein the location of the best focal plane (13) is ascertained based on an image evaluation of the focal planes (12) optically scanned by the z-scan (17), and
the image evaluation comprises an evaluation of an image contrast.

12. The autofocus method as claimed in claim 1, further comprising adapting the location of the scan range (14) anew, and performing the z-scan (17) anew as soon as a change in at least one of the site information or the calculated estimated value is ascertained based on a renewed retrieval of the external site information.

13. The autofocus method as claimed in claim 1, wherein the site information comprises target coordinates, and wherein the focusing lens (6) is already detuned while the imaging system (1) is moved to the target coordinates.

14. An optical imaging system (1) for visualizing an object (3) during a medical procedure, comprising:
a focusing lens (6) that is detunable by a focus actuator (7) in order to adapt a location of a focal plane (12) of the imaging system (1) along an optical z-axis (8) during a z-scan (17),
an image sensor (9) for recording image data, and
a controller (10) for controlling the focus actuator (7),
the controller (10) is configured to choose a location of a scan range (14) of the z-scan (17) on the optical z-axis (8) based on an estimated value (41) for a current working distance (11) and subsequently carry out the z-scan (17) within a scan range (14) whose location has been adapted based on the estimated value (41), in order to identify a best focal plane (13) within the scan range (14).

15. The optical imaging system (1) as claimed in claim 14, wherein the controller (10) is connectable or connected to an external system and configured to at least one of
a) retrieve the estimated value (41) from the external system, or
b) retrieve or obtain external site information from the external system
and calculate the estimated value (41) from said site information.

16. The optical imaging system (1) as claimed in claim 14, further comprising a zoom optical unit (4) that is adjustable by a zoom actuator (5), and wherein the controller (10) is configured to control the zoom actuator (5) based on the estimated value (41) to adapt a zoom level used during the z-scan (17).

17. The optical imaging system (1) as claimed in claim 16, wherein the controller (10) is further configured to control at least one of the focus actuator (7) or the zoom actuator (5) for autofocusing.

18. The autofocus method as claimed in claim 5, wherein said focal plane (12), the location of which corresponds to the corrected estimated value (41), is initially assessed using an image-based evaluation.
